(19) United States
(12) Patent Application Publication
(10) Pub. No.: US 2003/0145192 A1
(43) Pub. Date: Jul. 31, 2003

(54) Measures to enhance the security and safety of mail within the postal system through the use of encrypted identity stamps, encrypted identity envelopes, encrypted indentity labels and seals

(76) Inventor: George Calvin Turner, Springfield, VA (US)

Correspondence Address: GEORGE C. TURNER, 6813 HACKBERRY St., SPRINGFIELD, VA, 22150, US

(21) Appl. No.: 10/283,285

(22) Filed: Oct. 30, 2002

Related U.S. Application Data
(60) Provisional application No. 60/330,746, filed on Oct. 30, 2001.

(51) Int. Cl. G06F 9/00

(52) U.S. Cl. 713/1

(57) ABSTRACT

Through the use of Encrypted Identity Stamps, Encrypted Identity Envelopes, Encrypted Identity Labels and Seals, the security of the U.S. Postal System can be strengthened with implementation of a Sender's Identification System. The System will require each purchaser of postage to register with the Post Master General (or other organization(s) if so deemed by the government) to provide personal information. Updating the information will be required of each purchaser when changes are required for changes in address, name changes, marriage, etc. Death certificates will also have to be submitted by individuals authorized to certify death certificates. Through this collection and updating of information, a National Identity Tracking System can also be implemented or supplemented. Finally, postal employees and receivers of mail will feel a greater sense of calm when working with and receiving mail when a high probability of identifing the true identity of the sender of mail exists.

The current structure of the Federal Postal system in America has been challenged. The challenge has occurred in the safety of the mail and possible health hazards that may persist as a result of contaminants mailed within and out of the system.

This document outlines procedures and method and items that will restore confidence in the safety of all mail, both domestically and foreign.

### I. SENDERS IDENTIFICATION SYSTEM

Establish a Sender's Identification System. Each item processed through the Postal System will have a verifiable Mail Permit Number that will be issued by the U. S. Postal Service or other federal agency(s) or organization(s) authorized by the Federal Government. The identification numbers (s) will be ingrained, or imbedded, or scribed, or burned onto Scannable Encrypted Postage Stamps, Scannable Encrypted Envelopes, or other mailable packages/items/insignias/labels, etc.

### II. MAIL PERMIT IDENTIFICATION NUMBER(S)

This system will require the Post Master General to issue a Mail Permit Identification Number (s) to each person and organization in the United States. Individual and organizations wanting to receive mail from foreign countries will be required to register for two numbers (one to be a sender of mail and one to receive mail from foreign countries). There is a need to track incoming mail from foreign countries since foreign countries residents will not be issued identification numbers. Thus, the second number, Mail Receiver Number will address receiving mail from other countries.

### III. IDENTITY VERIFICATION PROCESS

The Identity Verification Process required to issue an identification number(s) should consist of at least one or more of the following identification techniques: (1) Finger-prints (use more than one finger on both hands incase a finger or hand is lost as the result of an accident), (2) DNA, (3) Eye Imaging or photo (we need to address the possibility of cosmetic surgery). The Identity Verification Process should also cross-reference a Social Security Number or Green Card Number, or Visa Number, Corporate Registration Number, and current mailing address (s). Note: As people and organizations relocate, Notices of Relocation received by the Postal Service should provide the capabilities to maintain updated addresses and name changes. Mail Permit Identification numbers(s) should also be required on each Death Certificate so that each number can be reported to the Post Master General for deactivation and deletion from the current system.

### IV. PERSONAL IDENTIFICATION IDENTIFIER

The Personal Identification Identifier is comprised of the assigned Mail Permit Identification Number(s), Identification Trait(s) and current residence address and mailing address. The information contained in the identifier will be imbedded into/onto Scannable Encrypted Personal Stamps, Scannable Personal Encrypted Envelopes, Scannable Encrypted Labels, etc. All mail processed through the system must contain one of the-personal identifiers.

### V. DISTRIBUTION/PURCHASE OF STAMPS, ENVELOPES AND OTHER MAILABLE ITEMS

To purchase stamps out of stamp machines, each individual will be required to key in a Mail Permit Identification Number (similar to the use of an ATM machine) and a stamp distribution machine will stamp the ID Number and the information contained in the Personal Identification Identifier into/onto stamps, envelopes or labels. To purchase stamps in postal offices, postal employees will be required to key in a Mail Permit Number (s) and again the information contained in the Personal Identification Identifier will be implanted into/onto stamps, envelopes, labels, etc.

### VI. PROCESSING MAIL ORIGINATING IN FOREIGN COUNTRIES

All mail originating in foreign countries should be processed through central cleaning and sealing locations. The cleaning processes may be similar to the current radiation methods employed by the postal service, or other proven methods that I may not be familiar with. Mail from some countries may also require a sealing process to go in conjunction with the cleaning/radiation methods.

### VII. MATERIAL COMPOSITIONS OF ENVELOPES, PACKAGES, BOXES AND OTHER CONTAINERS USED BY THE POSTAL SYSTEM

Envelopes and package wrappings should be made of non-porous, water-resistant materials. The idea here is to ensure that each mailed item has the capabilities to contain microscopic size contaminants (liquids and power forms).

### COLLAPSIBLE SEALED PORTABLE MAIL OPENING STATIONS/COVERS/TENTS

Finally, to further enhance protection of mail for postal patrons, a Mail Opening Station/Cover/Tents may be employed. They may be designed to set atop desks, fit into closets and any place in the home or office. There can also be an Office Size Mail Opening Booth, Chamber, Tent, etc. The idea here is to have a sealed placed to open mail to contain hazardous particles that may go airborne or spill on surfaces.

Copyright @ Oct. 29,2001, C. Turner_George

This Mail Identity System will assist the Department of Labor, Job Corps in locating young Job Corp graduates who are entitled to checks. The students are young and often do not have permanent addresses. This can be a huge savings to DOL and the students and the economy.

The Internal Revenue Service will have access to current mailing lists to send refund checks. The faster the refunds are spent, the economy benefits through more jobs and reduced unemployment.

Thus, this Mail Identity System may be used to assist parents who are entitled to receive child support payments through the Court Systems; there will be greater opportunities to locate non-paying parents. Federal and state governments benefit when parents care for their children, because it helps to invest in our youth of tomorrow and less assistance will be required of the states. Big dollar savings and reduced crime can be achieved here.

Finally, the Immigration and Naturalization Service will have an enhanced avenue to track students visiting on Student Visas. The INS will also have a tool to assist the agency in maintaining current files on Work Visas individuals. Other INS functions may also be possible with this system. National security may be enhanced and tremendous dollar savings can be achieved.

What I am claiming as my invention are revised procedures to improve the safety and security of mail, mailed and delivered within the postal system:

1. I am claiming security within the Postal System will be improved/enhanced through more extensive identification of the senders of mail, packages and other items with the use of Identity Encrypted Stamps (Cross Reference: Application #60/330,666; Filing Date Oct. 26, 2001), Identity Encrypted Envelopes (Cross Reference: Application #60/330,667; Filing Date, Oct. 26, 2001) and identity labels and seals.
I further claim that an enhanced postal identification system will enable law enforcement officials opportunities to narrow searches where threats are posed through the mail system to the country and to individuals.
I further claim that postal employees will have a greater feeling of calm in carrying out their assignments with Mail Sender's Identification System. Employee attendance will improve because employees will have less fear of getting illnesses that may be caused by contaminated mail. This also translates into personnel cost savings, greater work efficiency and productivity and less overtime pay.
I also claim that postal patrons will also have a greater feeling of calm when receiving mail if senders of mail can be identified positively and quickly.
Another claim may be made in that the Census Bureau may use the system in conducting censuses. Follow-up census studies may be made more accurately and efficiently with this system. Dollar savings can be tremendous.
This system will improve the efficiency and accuracy of political polls, surveys and marketing of bulk mail.
I claim that this system will assist the Social Security Administration in resending checks and correspondence to citizens who have moved or provided incorrect addresses. Again, this can generate tremendous cost savings.
